(19) United States
(12) Patent Application Publication
(10) Pub. No.: US 2013/0329151 A1
(43) Pub. Date: Dec. 12, 2013

(54) LIQUID CRYSTAL PANEL, MANUFACTURING PROCESS AND DISPLAY DEVICE THEREOF

(71) Applicants: Xiaolong Ma, Shenzhen (CN); Hong-Ji Huang, Shenzhen (CN)

(72) Inventors: Xiaolong Ma, Shenzhen (CN); Hong-Ji Huang, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/636,652

(22) PCT Filed: Jun. 28, 2012
(86) PCT No.: PCT/CN2012/077710

§ 371 Date: Sep. 21, 2012

(30) Foreign Application Priority Data
Jun. 6, 2012 (CN) 201210184639.0

(51) Int. Cl. G02F 1/1337; G02F 1/136; H01J 9/00

(52) U.S. Cl. 349/42; 445/6; 349/123; 349/130

(57) ABSTRACT

The present invention provides to a liquid crystal panel, which comprises: a first substrate, a second substrate, a coplanar transparent electrode layer and a liquid crystal layer. The first and second substrates have a first and second alignment films, respectively. The coplanar transparent electrode layer is disposed onto the second alignment film. The liquid crystal layer is disposed in a space between the first alignment film of the first substrate and the coplanar transparent electrode layer of the second substrate. The liquid crystal film comprises positive liquid crystal molecules and reactive mesogens (RMs). The liquid crystal panel of the present invention can overcome the problems of pollution and static electricity generated from the rubbing alignment in the IPS mode. In comparison with the PSVA mode, the present invention can simplify the manufacturing process and provide the advantages of high contrast, high response speed and wide viewing angle.

### FIELD OF THE INVENTION

The present invention relates to a field of a liquid crystal panel, and more particularly to a liquid crystal panel, a manufacturing process thereof, and a display device using the liquid crystal panel.

### BACKGROUND OF THE INVENTION

A liquid crystal display (LCD) comprises a liquid crystal panel and a backlight module, wherein the liquid crystal panel has a top substrate and a bottom substrate, and inner surfaces of the top and the bottom substrates opposed to each other are disposed with transparent electrodes, and a layer of liquid crystal molecules is disposed between the top and the bottom substrates. The transparent electrodes of the LCD generate an electric field to control a direction of liquid crystal molecules, so as to change a polarization status of light and carry out transmission and blocking of a light pathway by a polarizer, so that achieves an object of displaying.

The major technical parameters of evaluating the LCD includes: (1) contrast; (2) brightness; (3) signal response time; and (4) viewing angle, wherein the parameters of contrast, brightness and viewing angle are depended on a liquid crystal panel. The viewing angle is always an important and difficult key in the research of the liquid crystal panel, because a backlight source passes through a polarizer, a liquid crystal layer and an alignment film to output light with a direction. That is to say, most of light is emitted vertically from a screen. Thus, if viewing the liquid crystal panel with one of tilted angle, it is unable to see original colors, and even only totally white or totally black. To solve the problem, therefore, the researchers develop a wide-angle skill, so as to research and develop several modes of the liquid crystal panel described, as follows:

(1) Twisted Nematic (TN)

At the initiation, liquid crystal molecules are arranged parallel to a substrate, and encircled a normal of the substrate to be distorted 90 degrees. Due to polarization rotation effect, a polarized light passed through a polarizer has a direction of polarization which can follow the liquid crystal molecules to be rotated 90 degrees, so as to achieve the other side of the polarizer, wherein the direction of polarization of the light is exactly parallel to a transmission axis of the polarizer, so that the light can transmit. Therefore, TN mode presents a bright state before being charged, i.e. normally white; and presents a dark state after being charged. Most of liquid crystal molecules are arranged vertical to the substrate, wherein due to an anchoring force of an alignment layer, the liquid crystal molecules closed the alignment layer is still arranged parallel to the substrate, so as to generate optical latency causing light leakage. Therefore, because the TN mode LCD is dark-state transmittance, so the contrast is relatively poor.

(2) In-Plane-Switching (IPS)

The liquid crystal molecules of the liquid crystal layer are positive liquid crystals, and transparent electrodes are disposed on the bottom substrate. Before being charged, the liquid crystal molecules are arranged parallel to the substrate with no optical latency, so that it can acquire a darker state. After being charged, the liquid crystal molecules are parallel rotated to cause emitting polarized light to transmit, so that is normally black. An in-plane-switching (IPS) mode has the advantages of high contrast and high response speed, so as to be applied to television field. However, in the preparation process of the IPS mode liquid crystal panel, it is necessary to apply rubbing to the substrate, so as to apply initial alignment to the liquid crystal molecules. As a result, the rubbing alignment brings the issue of pollution, causes the decrease of the yield, and generates the problem of static electricity thereto, so that causes damage to transistors.

(3) Vertical Alignment (VA)

The VA mode and the IPS mode are the same to be normally black. But, the difference is that the liquid crystal molecules of the VA mode liquid crystal layer is negative liquid crystals, and the transparent electrodes are disposed on the top and the bottom substrates, respectively, so as to form an electric field that is vertical to the substrate. Before being charged, long axes of the liquid crystal molecules are vertical to the substrate, so as to be dark state; after being charged, the long axes of the liquid crystal molecules are parallel to the substrate and laid down. The initial alignment is also necessary to apply rubbing the substrate, so that it still generates the problems of pollution and static electricity, and the pre-tilted angle is also difficult to be controlled. To solve the problem of the VA mode initial alignment, there is a variety of derivative modes, such as a multi-domain vertical alignment (MVA) mode, a patterned vertical alignment (PVA) mode and a polymer stabilized vertical alignment (PSVA) mode, wherein the PSVA mode gradually become the mainstream with the advantages of high transmission, high contrast and high response speed.

As shown in FIG. 1, a distributional status of liquid crystal molecules and reactive mesogen/monomer (RMs) of a PSVA mode liquid crystal panel before being charged according to a conventional technology is illustrated. The PSVA mode liquid crystal panel of the conventional technology comprises a first substrate 10′, a second substrate 30′ and a liquid crystal layer 70′, wherein the liquid crystal layer 70′ is disposed between the first and the second substrates 10′, 30′. The first substrate 10′ has a first alignment film 20′ and a first transparent electrode 50′; and the second substrate 30′ has a second alignment film 40′ and a second transparent electrode 60′. The first alignment film 20′ is formed on a surface of the first substrate corresponding to the liquid crystal layer 70′, and the first transparent electrode 50′ is formed on the first alignment film 20′. The second alignment film 40′ is formed on a surface of the second substrate 30′ corresponding to the liquid crystal layer 70′ and the second transparent electrode 60′ is formed on the second alignment film 40′. The liquid crystal layer 70′ comprises liquid crystal molecules 701′ and RMs 702′, the liquid crystal molecules 701′ are negative liquid crystal molecules. And, the RMs 702′ has the character of being arranged vertical to a direction of the electric field, so as the same with the liquid crystal molecules 701′. Referring to FIG. 2, a distributional status of liquid crystal molecules and RMs after being charged and cured by ultraviolet (UV) according to FIG. 1 is illustrated. During the alignment, voltages are applied onto the first transparent electrode 50′ and the second transparent electrode 60′ to form an electric field vertical to the substrate, so that the liquid crystal molecules and the RMs closed to the surfaces of the first and the second alignment films 20′, 40′ generate a pre-tilted angle. In addition, due to anchoring effect of the alignment layer, the liquid crystal molecules 701′ and the RMs 702′ only can be tilted slightly an angle along a direction of the electric field, but not be laid down completely. After that, to apply UV to light the liquid crystal layer will fix the pre-tilted angle of the RMs, so as to finish the alignment.

However, the PSVA mode has no a rubbing alignment process, so that it can overcome the problems of the IPS mode about static electricity and pollution due to rubbing. But, because the viscosity of materials of the negative liquid crystals is larger than that of the positive liquid crystals, so that it causes that the responding speed is slower. In addition, it is necessary to form the top and bottom layers of electrodes. In comparison with the IPS mode, the preparation method of the PSVA is complicated.

As a result, the present invention provides a new display technique, which can overcome the problems of pollution and static electricity by the IPS mode rubbing alignment and simplify the manufacturing process, so that the liquid crystal panel and the liquid crystal displayer have the advantages of high contrast, high response speed and wide viewing angle.

### SUMMARY OF THE INVENTION

The first object of the present invention is to provide a manufacturing process of a liquid crystal panel, which combines the advantages of the IPS mode and the PSVA mode, so as to overcome the problems of pollution and static electricity by the IPS rubbing alignment and simplify the manufacturing process, so that the liquid crystal panel and the liquid crystal displayer can have the advantages of high contrast, high response speed and wide viewing angle.

The idea of the present invention is to provide a liquid crystal composition comprising RMs and positive liquid crystals, accompanied with a vertical alignment layer of VA mode, at the initiation, both long axes of the RMs and the positive liquid crystals are vertical to a substrate. An electrode is designed to be a coplanar transparent electrode. The coplanar transparent electrode forms a horizontal electric field, so that the RMs and the positive liquid crystal molecules on a surface of the substrate corresponding to the liquid crystal composition will generate a pre-tilted angle by effect of an alignment film. Through ultraviolet (UV) lighting the liquid crystal composition, the RMs with the pre-tilted angles are cured onto the surface, so as to finish a preparation of alignment.

To achieve the foregoing object, the present invention provides a technical solution, wherein a manufacturing process of a liquid crystal panel comprises steps of:

providing a first substrate and a second substrate, wherein a first alignment film is formed on the first substrate and a second alignment film is formed on the second substrate;

forming a coplanar transparent electrode layer on the second alignment film of the second substrate, wherein the coplanar transparent electrode layer comprises at least two transparent electrodes, and a slit is formed between the transparent electrodes;

filling a liquid crystal composition into a space between the first substrate and the second substrate to form a liquid crystal layer, wherein the liquid crystal layer is in contact with the first alignment film, the coplanar transparent electrode layer and the second alignment film in the slit;

applying voltages of different polarities onto the adjacent transparent electrodes, respectively, so as to form an electric field parallel to the substrate, so that a long axis of molecules of the liquid crystal composition is arranged based on a pre-tilted angle along a direction of the electric field; and applying an ultraviolet (UV) light thereto, so as to finish the liquid crystal alignment; and

attaching a polarizer onto one surface of the first and second substrates opposite to the liquid crystal layer, respectively, so as to form a liquid crystal panel;

wherein the liquid crystal composition comprises positive liquid crystal molecules and reactive mesogens (RMs).

In one embodiment of the present invention, the first alignment film and the second alignment film are vertical alignment films.

In one embodiment of the present invention, the coplanar transparent electrode layer is made of indium tin oxide (ITO).

In one embodiment of the present invention, the first substrate is a color filter (CF) substrate, and the second substrate is a thin film transistor (TFT) array substrate.

In a preferred embodiment of the present invention, a manufacturing process of a liquid crystal panel is provided, and comprises steps of:

providing a first substrate and a second substrate, wherein a first alignment film is formed on the first substrate and a second alignment film is formed on the second substrate, the first substrate is a color filter (CF) substrate and the second substrate is a thin film transistor (TFT) array substrate, and the first alignment film and the second alignment film are vertical alignment films;

forming a coplanar transparent electrode layer made of indium tin oxide (ITO) on the second alignment film of the second substrate, wherein the coplanar transparent electrode layer comprises at least two transparent electrodes, and a slit is formed between the transparent electrodes;

filling a liquid crystal composition into a space between the first substrate and the second substrate to form a liquid crystal layer, wherein the liquid crystal layer is in contact with the first alignment film, the coplanar transparent electrode layer and the second alignment film in the slit; wherein the liquid crystal composition comprises positive liquid crystal molecules and reactive mesogens (RMs);

applying voltages of different polarities onto the adjacent transparent electrodes, respectively, so as to form an electric field parallel to the substrate, so that a long axis of molecules of the liquid crystal composition is arranged based on a pre-tilted angle along a direction of the electric field; and applying an ultraviolet (UV) light thereto, so as to finish the liquid crystal alignment; and

attaching a polarizer onto one surface of the first and second substrates opposite to the liquid crystal layer, respectively, so as to form a liquid crystal panel.

The second object of the present invention is to provide a liquid crystal panel, comprising:

a first substrate having a first alignment film;

a second substrate having a second alignment film;

a coplanar transparent electrode film disposed on the second alignment film of the second substrate, wherein the coplanar transparent electrode layer comprises at least two transparent electrodes, and a slit is formed between the transparent electrodes; and

a liquid crystal layer disposed in a space between the first alignment film of the first substrate and the coplanar transparent electrode layer of the second substrate, wherein the liquid crystal layer has a liquid crystal composition comprising positive liquid crystal molecules and reactive mesogens (RMs);

wherein a plurality of the liquid crystal compositions arranged based on a pre-tilted angle are formed onto surfaces of the first alignment film and the coplanar transparent electrode layer corresponding to the liquid crystal layer, respectively.

In one embodiment of the present invention, the first alignment film and the second alignment film are vertical alignment films.

In one embodiment of the present invention, the coplanar transparent electrode layer is made of indium tin oxide (ITO).

In one embodiment of the present invention, the first substrate is a color filter (CF) substrate, and the second substrate is a thin film transistor (TFT) array substrate.

In one preferred embodiment of the present invention, a liquid crystal panel is provided, and comprises:

a first substrate having a first alignment film;

a second substrate having a second alignment film;

a coplanar transparent electrode film disposed on the second alignment film of the second substrate, wherein the coplanar transparent electrode layer comprises at least two transparent electrodes, and a slit is formed between the transparent electrodes; and

a liquid crystal layer disposed in a space between the first alignment film of the first substrate and the coplanar transparent electrode layer of the second substrate, wherein the liquid crystal layer has a liquid crystal composition comprising positive liquid crystal molecules and reactive mesogens (RMs);

a plurality of the liquid crystal compositions arranged based on a pre-tilted angle are formed onto surfaces of the first alignment film and the coplanar transparent electrode layer corresponding to the liquid crystal layer, respectively;

wherein the first substrate is a color filter (CF) substrate, and the second substrate is a thin film transistor (TFT) array substrate; the first alignment film and the second alignment film are vertical alignment films.

The third object of the present invention is to provide a liquid crystal device, which comprises any type of the liquid crystal panel, as the foregoing mentioned.

It should be noted that the liquid crystal molecules according to values of dielectric anisotropy are classified to positive liquid crystal molecules, neutral liquid crystal molecules and negative liquid molecules. The positive liquid crystal molecules of the present invention are generally referred to the liquid crystal molecules with positive values of dielectric anisotropy. While a voltage is charged greater than a certain degree, the long axes of the positive liquid crystal molecules are arranged parallel to the direction of the electric field.

The invention combines the advantages of the IPS mode and the PSVA mode, so that can overcome the problems of pollution and static electricity by the IPS mode rubbing alignment; and the present invention only needs to dispose the transparent electrode onto one substrate. In comparison with two layers transparent electrodes of the PSVA mode, the present invention can simplify the manufacturing process. The liquid crystal panel and the liquid crystal device of the present invention have the advantages of high contrast, high response speed and wide viewing angle.

### DESCRIPTION OF THE DRAWINGS

FIG. 1 is a distributional status schematic view of liquid crystal molecules and RMs of a PSVA mode liquid crystal panel before being charged according to a conventional technology;

FIG. 2 is a distributional status schematic view of liquid crystal molecules and RMs of the PSVA mode liquid crystal panel after being charged and cured by UV according to the conventional technology;

FIG. 3 is a distributional status schematic view of positive liquid crystal molecules and RMs of a liquid crystal panel before alignment according to one embodiment of the present invention; and

FIG. 4 is a distributional status schematic view of positive liquid crystal molecules and RMs of a liquid crystal panel during alignment process according to one embodiment of the present invention.

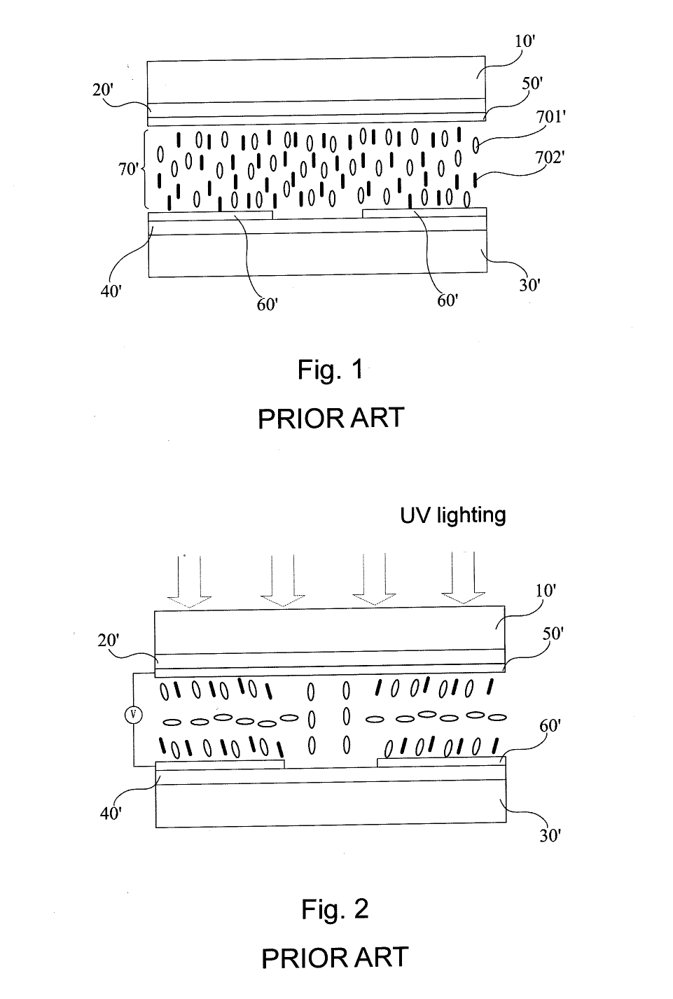

Reference numerals shown in figures:

10′ is a first substrate of a PSVA mode liquid crystal panel;

20′ is a first alignment film of the PSVA mode liquid crystal panel;

30′ is a second substrate of the PSVA mode liquid crystal panel;

40′ is a second alignment film of the PSVA mode liquid crystal panel;

50′ is a first transparent electrode of the PSVA mode liquid crystal panel;

60′ is a second transparent electrode of the PSVA mode liquid crystal panel;

70′ is a liquid crystal layer of the PSVA mode liquid crystal panel;

701′ are negative liquid crystal molecules of the PSVA mode liquid crystal panel;

702′ are the reactive mesogens (RMs) of the PSVA mode liquid crystal panel;

10 is a first substrate;

20 is a first alignment film;

30 is a second substrate;

40 is a second alignment film;

50 is a coplanar transparent electrode layer;

501 is a transparent electrode;

502 is a slit between the transparent electrodes;

60 is a liquid crystal layer;

601 are positive liquid crystal molecules;

602 are reactive mesogens (RMs);

70 is a first polarizer;

80 is a second polarizer.

### DETAILED DESCRIPTION OF THE PREFERRED EMBODIMENTS

The following is referred to embodiments for detail description the present invention, so that the embodiments are used to explain technical proposal of the present invention, but not limited thereto.

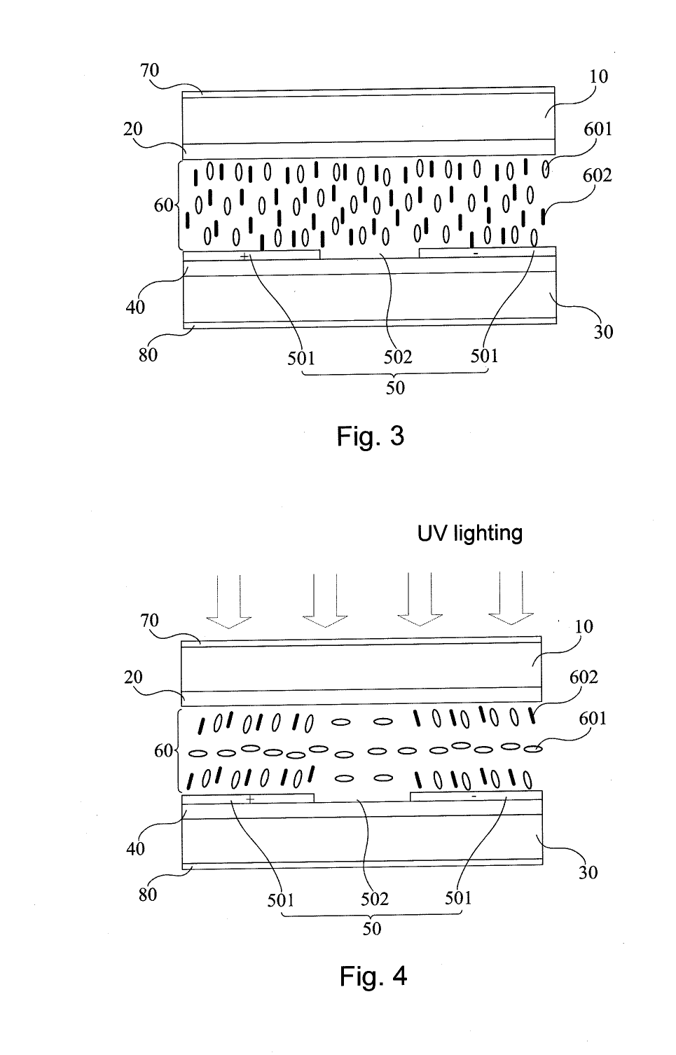

Referring now to FIG. 3, FIG. 3 is a sectional view of a liquid crystal panel before alignment according to one embodiment of the present invention. The liquid crystal panel comprises a first substrate 10, a second substrate 30, a first alignment film 20, a second alignment film 40, a coplanar transparent electrode layer 50, a liquid crystal layer 60, a first polarizer 70 and a second polarizer 80, wherein the first substrate 10 is opposite to the second substrate 30. The first alignment film 20 is formed on a surface of the first substrate 10 corresponding to the liquid crystal layer 60 and a second alignment film 40 is formed on a surface of the second substrate 30 corresponding to the liquid crystal layer 60; the first and the second alignment films 30,40 are vertical alignment films; the coplanar transparent electrode layer 50 is made of indium tin oxide (ITO) and formed on the second alignment film 40 of the second substrate 30; the coplanar transparent electrode layer 50 comprises at least two transparent electrodes 501, and a slit 502 is formed between the transparent electrodes 501. Referring to FIG. 3, the coplanar transparent electrode layer 50 of the embodiment according to the present invention is illustrated, and comprises: two coplanar parallel set of the transparent electrodes 501, wherein one of the transparent electrodes 501 (left side of the figure) is a positive electrode, and the other one of the transparent electrodes 501 (right side of the figure) is a negative electrode; the liquid crystal layer 60 disposed in a space between the first alignment film 20 of the first substrate 10 and the coplanar transparent electrode layer 50 of the second substrate 30, wherein the liquid crystal layer has a liquid crystal composition comprising positive liquid crystal molecules 601 and reactive mesogens (RMs) 602; the first polarizer 70 is disposed on the other surface of the first substrate 10 corresponding to the liquid crystal layer 60 and the second polarizer 80 is disposed on the other surface of the second substrate 30.

Referring to FIG. 3 again, because the present invention uses the positive liquid crystal molecules 601, the reactive mesogens (RMs) 602 and the vertical alignment, so that at the initial status (before being charged), both of the long axes of the positive liquid crystal molecules 401 and the RMs 402 are vertical to the first and the second substrates 10,30, so as to form dark state.

The embodiment also provides a manufacturing process of the foregoing liquid crystal panel, wherein the manufacturing process comprises the steps of:

providing a first substrate 10 and a second substrate 30, the first substrate is a color filter (CF) substrate, and the second substrate is a thin film transistor (TFT) array substrate; the manufacturing method of the first and the second substrates 10,30 uses the regular method of the art, so that the details thereof are omitted herein;

forming the first alignment film 20 on the first substrate 10 and forming a second alignment film 40 on the second substrate 30; wherein the first and the second alignment films 20,40 are vertical alignment films; the manufacturing method of the first and the second alignment films 20,40 uses the regular method of the art, so that the details thereof are omitted herein;

forming a coplanar transparent electrode layer 50 on the second alignment film 40 of the second substrate 30, wherein the coplanar transparent electrode layer 50 comprises at least two transparent electrodes 501, and a slit 502 is formed between the transparent electrodes; referring to FIG. 3, the coplanar transparent electrode layer 50 of the embodiment according to the present invention is illustrated, comprising: two coplanar parallel transparent electrodes 501, wherein one of the transparent electrodes 501 (left side of the figure) is a positive electrode, and the other one of the transparent electrodes 501 (right side of the figure) is a negative electrode; the transparent electrodes 501 are indium tin oxide (ITO) electrodes, the manufacturing method of the transparent electrodes 501 uses the regular method of the art, so that the details thereof are omitted herein;

filling a liquid crystal composition comprising positive liquid crystal molecules 601 and reactive mesogens (RMs) 602 into a space between the first substrate 10 and the second substrate 30 to form a liquid crystal layer 60, wherein the liquid crystal layer 60 is in contact with the first alignment film 30, the coplanar transparent electrode layer 50 and the second alignment film 40 in the slit 502;

applying voltages of different polarities onto the adjacent transparent electrodes 501, respectively, so as to form an electric field parallel to the first and the second substrates 10,30 and applying an ultraviolet (UV) light, so as to finish the liquid crystal alignment; and

attaching a first polarizer 70 and a second polarizer 80 onto the other surface of the first and second substrates 10,30 opposite to the liquid crystal layer 60, respectively, so as to form a liquid crystal panel.

Referring to FIG. 4, FIG. 4 is an alignment process of the embodiment according to the present invention. To apply voltages of different polarities onto the adjacent transparent electrodes 501 of the second substrate 30 (in the figure, the left side of the transparent electrode 501 is a positive electrode and the right side of the transparent electrode 501 is a negative electrode), so as to form an electric field parallel to the first and the second substrates 10,30, so that long axes of positive liquid crystal molecules 601 and reactive mesogens (RMs) 602 are arranged along a direction of the electric field; and the positive liquid crystal molecules 601 and the RMs 602 closed to surfaces of the alignment films 20,40 according to anchoring effect of the vertical alignment film are arranged based on a pre-tilted angle along a direction of the electric field; through UV light, the RMs 602 are cured on one surfaces of the first alignment film 20 and the coplanar transparent layer 50 corresponding to the liquid crystal film 60, respectively, so as to fix the pre-tilted angle of the RMs 602.

The present invention combines the advantages of the IPS mode and the PSVA mode and applies the positive liquid crystal molecules and the RMs, the vertical alignment film and the coplanar transparent electrode layer, all of which can finish the alignment through the conditions of being-charged and UV lighting, so that it can overcome the problems of pollution and static electricity by the IPS mode rubbing alignment. In addition, the present invention only needs to dispose the transparent electrode onto one substrate. In comparison with the two layers transparent electrodes of PSVA mode, the present invention can simplify the manufacturing process. Moreover, the liquid crystal panel and the liquid crystal device of the present invention have the advantages of high contrast, high response speed and wide viewing angle.

As described on, the present invention has been described with related embodiments thereof and the above embodiments are only patterns to carry out the present invention. It is necessary to note that the disclosed embodiments with no limited the scope of the invention. Conversely, many changes and modifications to the described embodiment can be carried out without departing from the scope and the spirit of the invention that is intended to be limited only by the appended claims.

1. A manufacturing process of a liquid crystal panel, comprising steps of:
providing a first substrate and a second substrate, wherein a first alignment film is formed on the first substrate and a second alignment film is formed on the second substrate;
forming a coplanar transparent electrode layer on the second alignment film of the second substrate, wherein the coplanar transparent electrode layer comprises at least two transparent electrodes, and a slit is formed between the transparent electrodes;
filling a liquid crystal composition into a space between the first substrate and the second substrate to form a liquid crystal layer, wherein the liquid crystal layer is in contact with the first alignment film, the coplanar transparent electrode layer and the second alignment film in the slit; and the liquid crystal composition comprises positive liquid crystal molecules and reactive mesogens (RMs);
applying voltages of different polarities onto the adjacent transparent electrodes, respectively, so as to form an electric field parallel to the substrate, so that a long axis of molecules of the liquid crystal composition is arranged based on a pre-tilted angle along a direction of the electric field; and applying an ultraviolet (UV) light thereto, so as to finish the liquid crystal alignment; and
attaching a polarizer onto one surface of the first and second substrates opposite to the liquid crystal layer, respectively, so as to form a liquid crystal panel.

2. The manufacturing process according to claim 1, wherein the first alignment film and the second alignment film are vertical alignment films.

3. The manufacturing process according to claim 1, wherein the coplanar transparent electrode layer is made of indium tin oxide (ITO).

4. (canceled)

5. (canceled)

6. (canceled)

7. (canceled)

8. (canceled)

9. (canceled)

10. (canceled)

11. The manufacturing process according to claim 2, wherein the coplanar transparent electrode layer is made of indium tin oxide (ITO).

12. The manufacturing process according to claim 1, wherein the first substrate is a color filter (CF) substrate, and the second substrate is a thin film transistor (TFT) array substrate.

13. The manufacturing process according to claim 2, wherein the first substrate is a color filter (CF) substrate, and the second substrate is a thin film transistor (TFT) array substrate.

14. A manufacturing process of a liquid crystal panel, comprising steps of:
providing a first substrate and a second substrate, wherein a first alignment film is formed on the first substrate and a second alignment film is formed on the second substrate, the first substrate is a color filter (CF) substrate and the second substrate is a thin film transistor (TFT) array substrate, and the first alignment film and the second alignment film are vertical alignment films;
forming a coplanar transparent electrode layer made of indium tin oxide (ITO) on the second alignment film of the second substrate, wherein the coplanar transparent electrode layer comprises at least two transparent electrodes, and a slit is formed between the transparent electrodes;
filling a liquid crystal composition into a space between the first substrate and the second substrate to form a liquid crystal layer, wherein the liquid crystal layer is in contact with the first alignment film, the coplanar transparent electrode layer and the second alignment film in the slit; wherein the liquid crystal composition comprises positive liquid crystal molecules and reactive mesogens (RMs);
applying voltages of different polarities onto the adjacent transparent electrodes, respectively, so as to form an electric field parallel to the substrate, so that a long axis of molecules of the liquid crystal composition is arranged based on a pre-tilted angle along a direction of the electric field; and applying an ultraviolet (UV) light thereto, so as to finish the liquid crystal alignment; and
attaching a polarizer onto one surface of the first and second substrates opposite to the liquid crystal layer, respectively, so as to form a liquid crystal panel.

15. A liquid crystal panel, comprising:
a first substrate having a first alignment film;
a second substrate having a second alignment film;
a coplanar transparent electrode film disposed on the second alignment film of the second substrate, wherein the coplanar transparent electrode layer comprises at least two transparent electrodes, and a slit is formed between the transparent electrodes; and
a liquid crystal layer disposed in a space between the first alignment film of the first substrate and the coplanar transparent electrode layer of the second substrate, wherein the liquid crystal layer has a liquid crystal composition comprising positive liquid crystal molecules and reactive mesogens (RMs);
wherein a plurality of the liquid crystal compositions arranged based on a pre-tilted angle are formed onto surfaces of the first alignment film and the coplanar transparent electrode layer corresponding to the liquid crystal layer, respectively.

16. The liquid crystal panel according to claim 15, wherein the first alignment film and the second alignment film are vertical alignment films.

17. The liquid crystal panel according to claim 15, wherein the coplanar transparent electrode layer is made of indium tin oxide (ITO).

18. The liquid crystal panel according to claim 16, wherein the coplanar transparent electrode layer is made of indium tin oxide (ITO).

19. The liquid crystal panel according to claim 15, wherein the first substrate is a color filter (CF) substrate, and the second substrate is a thin film transistor (TFT) array substrate.

20. The liquid crystal panel according to claim 16, wherein the first substrate is a color filter (CF) substrate, and the second substrate is a thin film transistor (TFT) array substrate.
